(19) United States
(12) Patent Application Publication
(10) Pub. No.: US 2011/0108205 A1
(43) Pub. Date: May 12, 2011

(54) Systems And Methods For Providing A Safety Cord For Window Covering Systems

(76) Inventor: Steven J. Levin, St. Louis, MO (US)

(21) Appl. No.: 12/615,574

(22) Filed: Nov. 10, 2009

(51) Int. Cl. A47H 5/08; A47H 5/00; E06B 9/56; E06B 9/30

(52) U.S. Cl. 160/84.01; 160/405; 160/340; 160/319; 160/168.1 R; 24/115 F

(57) ABSTRACT

The present teachings relate to window covering systems, and more particularly to systems and methods for providing a window covering with safety clutch cord structured and operable to be severable upon application of a longitudinal force greater than predetermined threshold force.

### FIELD

The present teachings relate to window covering systems that include a safety clutch cord.

### BACKGROUND

The statements in this section merely provide background information related to the present disclosure and may not constitute prior art.

Many window covering systems, such as various types of roller shade systems, horizontal pleated shade systems, vertical pleated shade systems, horizontal louvered blind systems, vertical louvered blind systems, drape or curtain systems etc., utilize a closed, or continuous, loop clutch cord to operate the respective system. More particularly, longitudinal movement of the closed, or continuous, loop clutch cord, i.e., pulling on any portion of the clutch cord, rotates a drive wheel of the respective clutch mechanism, which in turn operates the clutch mechanism to move, or transition, a window covering of the window covering system, e.g., one or more shades or sets blinds, to any desired open or closed position.

Such closed, or continuous, loop clutch cords present various hazards, dangers, and risks, particularly to children, because of the closed, or continuous, loop nature of the clutch cords. Particularly, because the cords are typically fabricated into a closed, or continuous, loop, children can get their hands, arms, legs, feet, or worse yet, their neck, caught in the loop resulting in serious injury or death.

### SUMMARY

Generally, the present disclosure provides systems and methods for providing a safety clutch cord for window covering systems.

In various embodiments, the present disclosure provides a safety coupling for a clutch cord of a window covering system. In such embodiments, the safety coupling includes a first connector connected to a first end of the clutch cord of the window covering system, and a second connector connected to a second end of the clutch cord. The second connector is magnetically connectable to the first connector to structure, form or configure the clutch cord in a closed, or continuous, loop. The closed loop clutch cord is operable, via application of longitudinal force to any portion of the closed loop clutch cord (i.e., by pulling on any portion of the closed loop clutch cord), to operate a clutch mechanism of the window covering system. Operation of the clutch mechanism causes at least a portion of a window covering of the window covering system to move, or transition, between a first position and a second position.

Moreover, the first and second connectors are magnetically connectable with a particular amount of attractive force. The amount of attractive force between the first and second connectors is such that when a longitudinal force below a predetermined threshold force is applied to either of the first or second connectors, via application of a longitudinal force below the predetermined threshold force to any portion of the closed loop clutch cord, the first and second connectors will remain connected, thereby resulting in movement of the closed loop clutch cord, which will function to operate the clutch mechanism to move the at least a portion of the window covering between the first position and the second position. Additionally, the amount of attractive force between the first and second connectors is such when a longitudinal force greater than or equal to the predetermined threshold force is applied to either of the first or second connectors, via application of a longitudinal force greater than or equal to the predetermined threshold force to any portion of the closed loop clutch cord, the first and second connectors will decouple severing the closed loop clutch cord.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is a schematic of a portion of an exemplary window covering system, in accordance with various embodiments of the present disclosure.

FIG. 2A is schematic of the window covering system shown in FIG. 1, illustrating a safety clutch cord of the window covering system in a coupled configuration, in accordance with various embodiments of the present disclosure.

FIG. 2B is schematic of the window covering system shown in FIG. 1, illustrating the safety clutch cord of the window covering system in a decoupled configuration, in accordance with various embodiments of the present disclosure.

FIG. 3A is schematic of a portion of the safety clutch cord of the window covering system shown in FIG. 1, illustrating a safety coupling of the window covering system, in accordance with various embodiments of the present disclosure.

FIG. 3B is an exploded view of safety coupling shown in FIG. 3A, in accordance with various embodiments of the present disclosure.

FIG. 4A is schematic of a portion of the safety clutch cord of the window covering system shown in FIG. 1, illustrating a safety coupling of the window covering system, in accordance with various other embodiments of the present disclosure.

FIG. 4B is schematic of a portion of the safety clutch cord of the window covering system shown in FIG. 1, illustrating an exploded view of a safety coupling of the window covering system, in accordance with yet other embodiments of the present disclosure.

FIG. 5 is schematic of a portion of the safety clutch cord of the window covering system shown in FIG. 1, illustrating a safety clutch cord holding button of the window covering system, in accordance with various other embodiments of the present disclosure.

Corresponding reference numerals indicate corresponding parts throughout the several views of drawings.

### DETAILED DESCRIPTION

The following description is merely exemplary in nature and is in no way intended to limit the present teachings, application, or uses. Throughout this specification, like reference numerals will be used to refer to like elements.

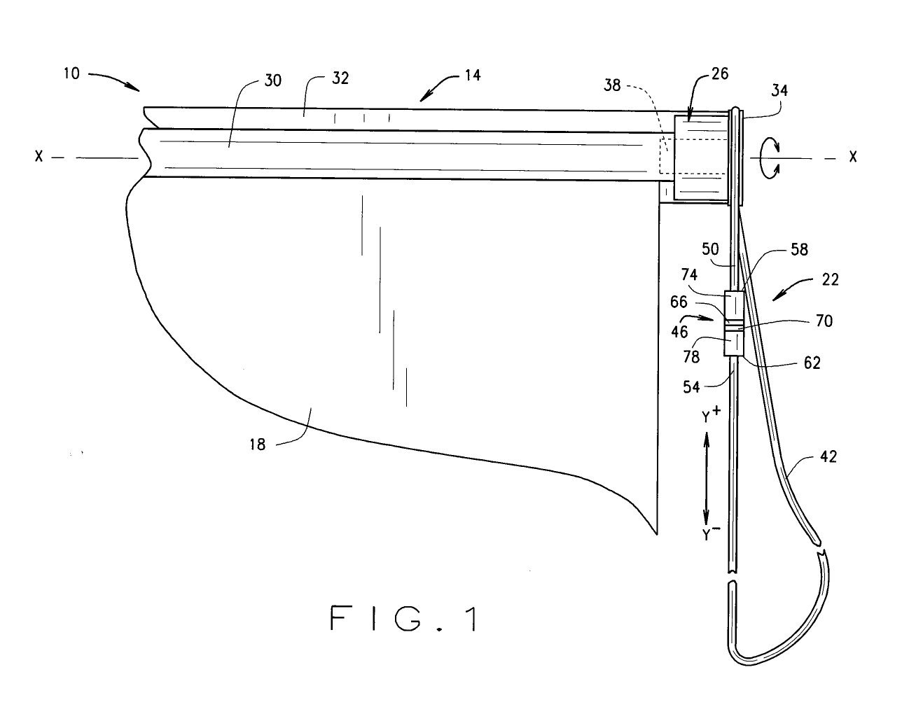

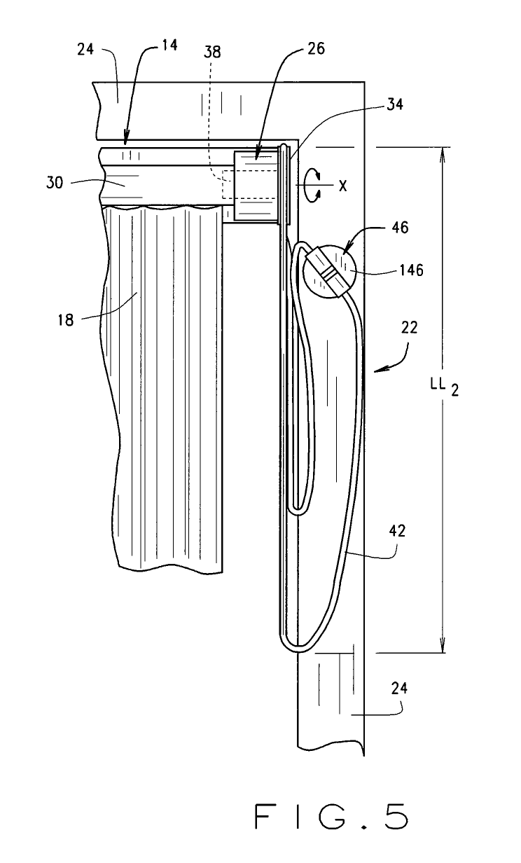

FIG. 1 illustrates a portion of a window covering system 10, in accordance with various embodiments of the present disclosure. Generally, the window covering system 10 includes a head unit 14, a window covering 18 and a safety clutch cord 22. In various implementations, the head unit 14 is mountable to or within a window opening (not shown). That is, the head unit 14 can be mounted to the structure 24 (shown in FIG. 5) forming a window opening, e.g., the window framework and/or wall covering, using any suitable mounting means, e.g., screwing, gluing, nailing, riveting, etc.

Generally, the head unit 14 includes a clutch mechanism 26 and a window covering movement mechanism 30 connected to the clutch mechanism 26. In various embodiments, the head unit 14 can include a housing 32 that encloses the window covering movement mechanism 30 and at least a portion of the clutch mechanism 26. A portion of the head unit housing 32 has been removed in FIG. 1 to more clearly illustrate the clutch mechanism 26 and the window covering movement mechanism 30.

The window covering 18 is connected to the window covering movement mechanism 30 such that operation of the window covering movement mechanism 30 will cause at least a portion of the window covering to move, or transition, from one position to another. More specifically, the clutch mechanism 26 includes a drive wheel 34 and drive spindle 38 to which the window covering movement mechanism 30 is connectable. The drive spindle 38 is fixedly coupled to the drive wheel 34 and orthogonally extending from an inner face of the drive wheel 34. The window covering movement mechanism 30 can be fixedly or removably connected to, on or over the drive spindle 38 in any manner suitable to engage the window covering movement mechanism 30 with the drive spindle 38. Particularly, the window covering movement mechanism 30 is engaged with the drive spindle 38 such that rotation of the drive wheel 34 about an X axis will rotate the drive spindle 38 about the X axis, which will operate the window covering movement mechanism 30 to move at least a portion of the window covering 18, as described below.

The window covering 18 is connected to the window covering movement mechanism 30 such that operation of the window covering movement mechanism 30 will cause at least a portion of the window covering 18 to move, or transition, between various opened and closed positions. More particularly, rotation of the drive wheel 34 in a first direction, and the resulting rotation for drive spindle 38, will operate the window covering movement mechanism 30 to cause at least a portion of the window covering 18 to move from a first position, which can be any possible closed position of the respective portion of the window covering 18, to a second position, which can be any other possible opened position of the respective portion of the window covering 18. Similarly, rotation of the drive wheel 34 a second direction that is opposite the first direction, and the resulting rotation for drive spindle 38, will operate the window covering movement mechanism 30 to cause at least a portion of the window covering 18 to move from a first position, which can be any possible opened position of the respective portion of the window covering 18, to a second position, which can be any possible closed position of the respective portion of the window covering 18. Hence, rotation of the drive wheel 34 will operate the window covering movement mechanism 30, thereby causing a least a portion of the window covering 18 to move between any possible opened or closed position of the respective portion of the window covering 18 and any other possible opened or closed position of the respective portion of the window covering 18.

The window covering 18 can be any type of window covering, such as a roller shade, a horizontal pleated shade, a vertical pleated shade, horizontal louvered blinds, vertical louvered blinds, drapes or curtains, etc. Importantly, although FIG. 1 exemplarily illustrates the window covering 18 as a roller shade, it should be understood that the window covering 18 can be any other suitable type of window covering and remain within the scope of the present disclosure. Additionally, the window covering 18 can be connected to the window covering drive mechanism 30 in any manner suitable to impart movement of at least a portion of the respective window covering 18 upon operation of the window covering drive mechanism, as described herein. Furthermore, the window covering movement mechanism 30 can be any mechanism, device, apparatus or system structured and operable to impart movement on at least a portion of the window covering 18 when driven, or operated, by the clutch mechanism 26, i.e., the drive spindle 38, as described herein.

For example, in various embodiments, the window covering 18 can be a roller shade and the window covering movement mechanism 30 can be a cylindrical barrel, e.g., a tube or rod, to which a top edge of the roller shade 18 is connected. In such embodiments, the window covering barrel 30 is engaged with the drive spindle 38 such that rotation of the drive wheel 34 rotates the window covering barrel 30, thereby causing the roller shade 18 to wrap around, or unwrap from, the window covering barrel 30, depending on the direction in which the drive wheel 34 is rotated.

Alternatively, in various other exemplary embodiments, the window covering 18 can be a horizontal pleated shade and the window covering movement mechanism 30 can be a cylindrical barrel, e.g., a tube or rod, to which a plurality of retracting cords are connected. The retracting cords are interlaced with the horizontal pleated shade 18 and connected to a bottom portion of the horizontal pleated shade 18. In such embodiments, the window covering barrel 30 is engaged with the drive spindle 38 such that rotation of the drive wheel 34 rotates the window covering barrel 30, thereby causing the retracting cords to wrap around the window covering barrel 30 to raise the horizontal pleated shade 18, or unwrap from the window covering barrel 30 to lower the horizontal pleated shade 18, depending on the direction in which the drive wheel 34 is rotated.

In still other exemplary embodiments, the window covering 18 can be a vertical blinds system and the window covering movement mechanism 30 can be a track and pulley system, e.g., one or more guide tracks along which a plurality of blind carriages are moved via longitudinal movement of at least one carriage cord within the guide track(s). In such embodiments, the vertical blind system 18 includes a plurality of blinds that are connected to the blind carriages such that movement of the blind carriages results in movement of the blinds. Furthermore, in such embodiments, the track and pulley system 30 is engaged with the drive spindle 38 such that rotation of the drive wheel 34 rotates the drive spindle 38, which, in turn, operated the track and pulley system 30 such that blind carriages and blinds are horizontally moved to any desired opened or closed position, depending on the direction in which the drive wheel 34 is rotated.

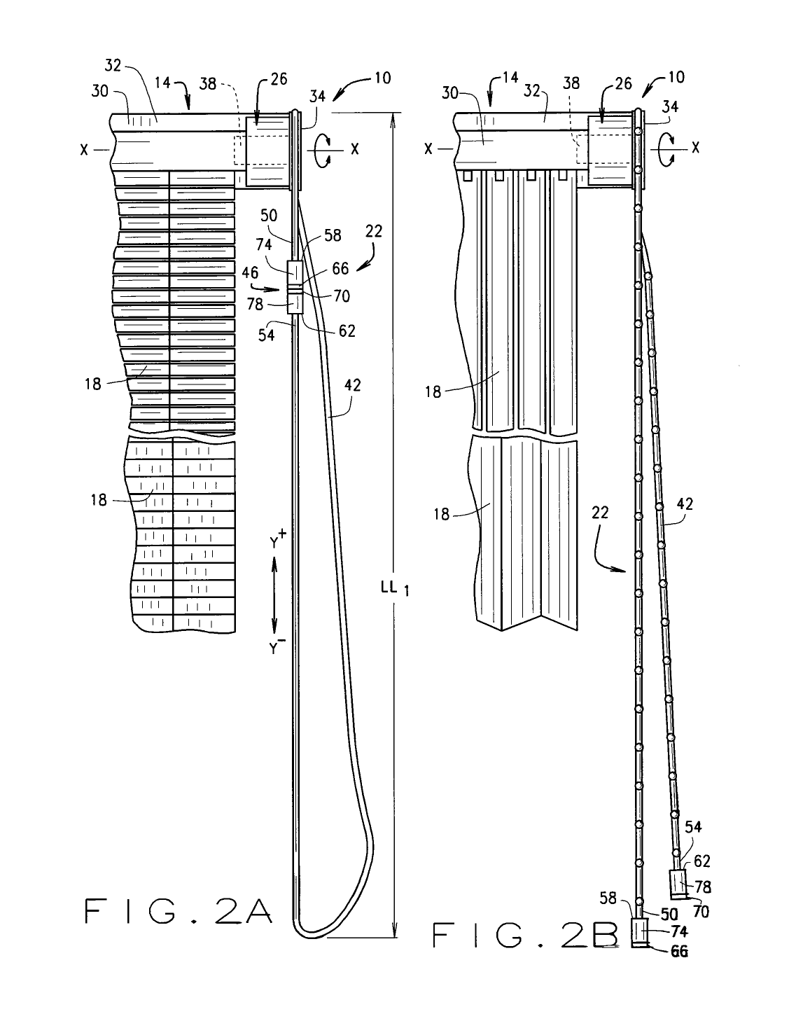

It is envisioned that the window covering system 10, as disclosed herein, can be any window covering system that utilizes a closed, or continuous, loop clutch cord, e.g., the safety clutch cord 22, as described herein. Moreover, in light of the exemplary embodiments described herein, one skilled in the art will readily and clearly understand that the window covering system 10, as described herein, can include any window covering system that utilizes a closed, or continuous, loop clutch cord, e.g., the safety clutch cord 22, such as a roller shade system (exemplarily illustrated in FIG. 1), a horizontal pleated shade system (exemplarily illustrated in the bottom portion of the window covering 18 FIG. 2A), a vertical pleated shade system (exemplarily illustrated in the bottom portion of the window covering 18 FIG. 2B), a horizontal louvered blinds system (exemplarily illustrated in the top portion of the window covering 18 FIG. 2A), a vertical louvered blinds system (exemplarily illustrated in the top portion of the window covering 18 FIG. 2B), drapes or curtain systems (exemplarily illustrated in FIG. 5), etc.

As used herein, the phrase at least a portion of the window covering is meant to describe any portion of the respective window covering 18 that is moved via operation of the window covering movement mechanism 30 as driven by rotation of the drive wheel 34. For example, rotation of the drive wheel 34, and hence the drive spindle 38, can cause any portion of the respective window covering 18 to move from one position to another position. Or, rotation of the drive wheel 34, and hence the drive spindle 38, can cause the entire respective window covering 18 to move from one position to another position.

With additional reference to FIGS. 2A and 2B, the safety clutch cord 22 includes a clutch cord 42, also referred to as a pull cord or control cord, and safety coupling 46 integrally disposed within the clutch cord 42. The clutch cord 42 is disposed about a drive wheel 34 of the clutch mechanism 26 within a channel formed in the peripheral edge of the drive wheel 34. Particularly, the clutch cord is disposed about the drive wheel 34 such that movement of the safety clutch cord 22 generally in the Y⁺ or Y⁻ direction rotates the drive wheel 34 to operate the clutch mechanism 26 to operate the window covering movement mechanism 30 to move at least a portion of the window covering between the first position and the second position, as described above. The clutch cord 42 can comprise any flexible device, mechanism or apparatus suitable for disposition about drive wheel 34 and suitable to impart forces on the drive wheel 34 sufficient to rotate the drive wheel 34 and drive the window covering movement mechanism 14 when a longitudinal force is applied to any portion of the clutch cord 42, i.e., a force in a direction that is substantially coaxial with the portion of the clutch cord 42 to which the force is being applied. For example, in various embodiments, the clutch cord 42 can comprise a woven fabric or synthetic material rope or cord, e.g., a nylon or cotton rope or cord, or a metal cable or chain, as exemplarily illustrated in FIG. 2A.

Alternatively, in various other embodiments, the clutch cord 42 can comprise a synthetic or plastic beaded rope or cord, as exemplarily illustrated in FIG. 2B. In such embodiments, the channel formed in the peripheral edge of the drive wheel 34 can include semi-spherical recesses spaced along the channel to mate with the beads of the beaded rope or cord, thereby aiding in imparting the forces on the drive wheel 34 sufficient to rotate the drive wheel 34.

The safety coupling 46 is structured and operable to detachably connect a first end 50 and second end 54 of the clutch cord 42. More specifically, the safety coupling 46 includes a first connector 58 connectable to the first end 50 of the clutch cord 42, and a second connector 62 connectable to the second end 54 of the clutch cord 42. The safety coupling 46 additionally includes a first magnet 66 disposed at distal end of a body 74 of the first connector 58, and a second magnet 70 disposed at the distal end of a body 78 of the second connector 62. It should be understood that as used herein, the terms first and second ends 50 and 54 refer to the end portions of the clutch cord 42, e.g., the portions of the clutch cord 42 near the respective terminal ends of the clutch cord 42. The first and second magnets 66 and 70 can be disposed, i.e., mounted, connected, coupled or attached, to the distal ends of the respective connector bodies 74 and 78 in any suitable fashion. For example, the first and second magnets 66 and 70 can be glued, ultrasonically welded, snapped, screwed, friction fitted, etc., into or on the distal ends of the respective connector bodies 74 and 78.

The first and second connectors 58 and 62 can be connected to the respective clutch cord first and second ends 50 and 54 in any manner suitable to fixedly retain the first and second connectors 58 and 62 on the respective clutch cord first and second ends 50 and 54, as described below. Additionally, the first and second magnets 66 and 70 are disposed on the distal ends of the respective first and second connector bodies 74 and 78 such that when placed in close proximity to each other, and attractive magnetic flux field of a predetermined force, or strength, is generated between the first and second magnets 66 and 70. Accordingly, in response to the attractive magnetic flux field, the first and second magnets 66 and 70, and hence, first and second connectors 58 and 62, magnetically connect when brought within close proximity to each other, thereby forming, or structuring, the clutch cord 42 in a closed, or continuous, loop. The closed loop clutch cord 42 is operable, via application of longitudinal force to any portion of the closed loop clutch cord 42, to operate the head unit 14 and clutch mechanism 26 to move at least a portion of the window covering between the first position and the second position, as described above.

More particularly, the first and second magnets 66 and 70 are selected have a magnetic structure that will generate a predetermined amount of attractive force when placed in close proximity to each other. That is, the first and second magnets 66 and 70 are selected to have magnetic structures that will generate an attractive magnet flux field sufficient to maintain connection of the first and second connectors 58 and 62 until a predetermined amount of longitudinal force is applied to either of the first or second connectors 58 or 62, via application of longitudinal force to any portion of the closed loop clutch cord 42. The predetermined amount of longitudinal force applied to either of the first or second connectors 58 or 62 that will cause the first and second connectors 58 and 62 to decouple, is referred to herein as the predetermined threshold force.

Still more specifically, the first and second connectors 58 and 62 are magnetically connectable to each other, via the first and second magnets 66 and 70, with an amount of attractive force such that application of a longitudinal force to the closed loop clutch cord 42 that is below the threshold force will operate the clutch mechanism 26 and head unit 14, as described above. However, application of a longitudinal force equal to or greater than the threshold force will decouple, i.e., separate or pull apart, the first and second connectors 58 and 62, thereby severing the closed loop safety clutch cord 22.

Still yet more specifically, when a longitudinal force below the predetermined threshold force is applied to either of the first or second connectors 66 or 70, via application of a longitudinal force below the predetermined threshold force to any portion of the closed loop clutch cord 42, the first and second connectors 58 and 62 will remain connected and the resulting movement of the closed loop clutch cord 42 will function to rotate the drive wheel 34 and operate the head unit clutch mechanism 30 to move at least a portion of the window covering 18 between the first position and the second position. Conversely, when a longitudinal force greater than or equal to the predetermined threshold force is applied to either of the first or second connectors 58 or 70, via application of a longitudinal force greater than or equal to the predetermined threshold force to any portion of the closed loop clutch cord 42, the first and second connectors 58 and 70 will decouple severing the closed loop safety clutch cord 22.

The threshold force is predetermined based on the structure of the respective clutch mechanism 26, head unit 14 and window covering 18 to be a force sufficient to retain the magnetic connection of the respective first and second connectors 58 and 70 while a longitudinal force sufficient to rotate the respective clutch mechanism 26 and operate the respective head unit 14 to move at least a portion of the respective window covering from the first position to the second position is applied to any portion of the closed loop clutch cord 42. But, the predetermined threshold force is insufficient to retain the magnetic connection of the respective first and second connectors 58 and 70 when a longitudinal force greater than a force necessary to operate the respective clutch mechanism 26 and head unit 14 to move the respective window covering 18 is applied to any portion of the closed loop clutch cord 42. For example, the predetermined threshold force is selected to be sufficient to retain connection of the first and second connectors 58 and 70 during operation of the clutch mechanism 26 and head unit 14, as described above, but, also selected such that if a child were to have their arm, leg, or worse begin to become entangled in the closed loop clutch cord 42 of the safety clutch cord 22 of the present disclosure, the resulting force would be greater than the predetermined threshold force such that the first and second connectors 58 and 70 would easily and readily decouple, severing the closed loop clutch cord 42, thereby allowing the child's arm or leg to fall free from the severed safety clutch cord 22.

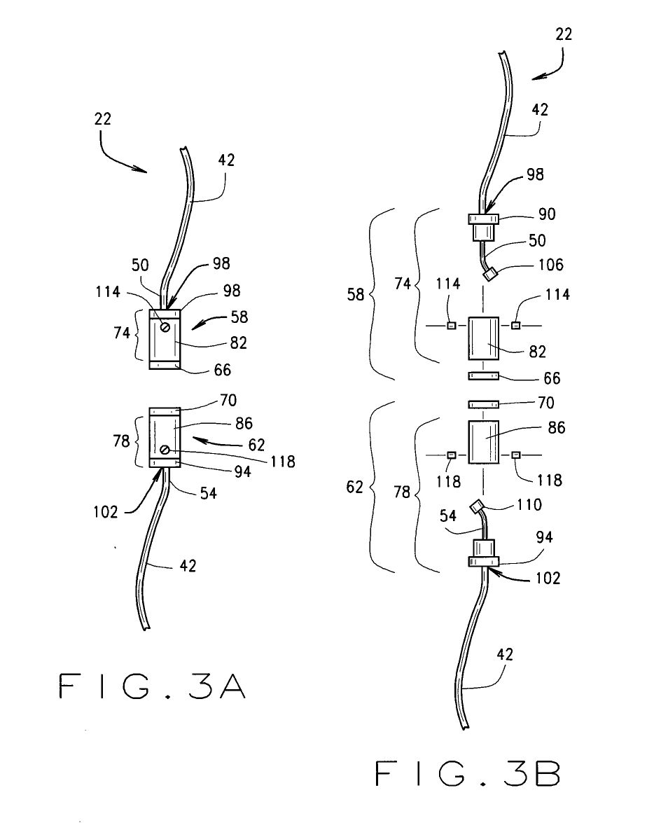

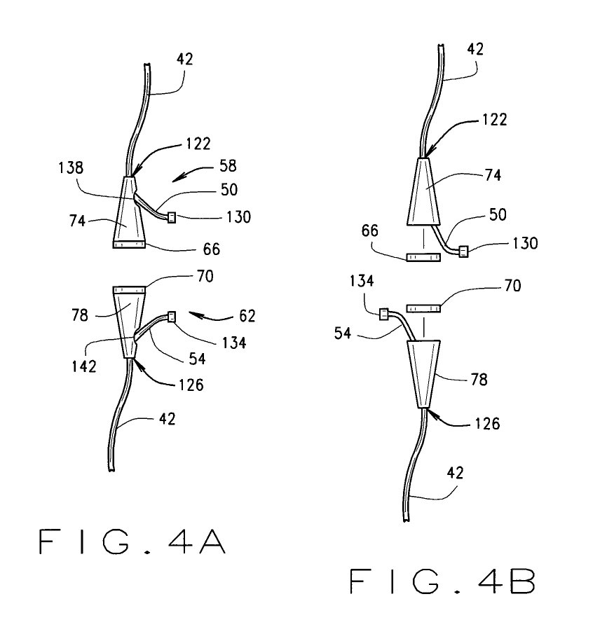

Referring now to FIGS. 3A, 3B, 4A and 4B, the first and second connectors 58 and 62 can each be any magnetic connector suitable for connecting to the respective clutch cord first and second ends 50 and 54 and magnetically coupling together.

For example, as illustrated in FIGS. 3A and 3B, in various embodiments, the first and second connector bodies 74 and 78 can respectively include a first and second housing 82 and 86, e.g., cylindrical housings, having the first and second magnets 66 and 70 disposed at the respective distal end thereof. Additionally, the first and second connector bodies 74 and 78 can respectively include a first and second end cap 90 and 94 connectable to a proximal end of the respective first and second body housings 82 and 86. The first and second end caps 90 and 94 respectively include a first and second aperture 98 and 102 through which the respective first or second clutch cord ends 50 and 54 can be inserted.

Furthermore, the first and second connector bodies 74 and 78 can respectively include a first and second cord retention means 106 and 110 structured and operable to fixedly retain the respective first and second end caps 90 and 102 on the respective first or second ends 50 and 54 of the clutch cord 42. The first and second cord retention means 106 and 110 can be any device, component, apparatus, system or mechanism suitable to fixedly retain the respective first and second end caps 90 and 102 on the respective first and second clutch cord ends 50 and 54.

For example, in various embodiments, each of the first and second retentions means 106 and 110 can include a washer through which the respective clutch cord ends 50 and 54 are inserted and a knot tied in the respective clutch cord ends 50 and 54. Accordingly, the knots prevent the respective clutch cord ends 50 and 54 from pulling through respective washers, and the washers prevent the respective clutch cord ends 50 and 54 from pulling through respective end cap apertures 98 and 102, thereby retaining the respective end caps 90 and 102 on the respective clutch cord ends 50 and 54. Alternatively, in various other exemplary embodiments, the first and second retention means 106 and 110 can be a knot tied in the respective clutch cord ends 50 and 54 and sized to prevent the respective clutch cord ends 50 and 54 from pulling through respective end cap apertures 98 and 102, thereby retaining the respective end caps 90 and 102 on the respective clutch cord ends 50 and 54. In yet other exemplary embodiments, the first and second retention means 106 and 110 can be a compression fitting fixedly attached to the respective clutch cord ends 50 and 54, e.g., compressed on to the respective clutch cord ends 50 and 54, such that the respective clutch cord ends 50 and 54 are prevented from pulling through respective end cap apertures 98 and 102, thereby retaining the respective end caps 90 and 102 on the respective clutch cord ends 50 and 54.

Still further, the first and second connector bodies 74 and 78 can respectively include one or more first and second end cap retention means 114 and 118 structured and operable to fixedly retain the respective first and second end caps 90 and 102 on the proximal end of the respective first or second connector body housings 82 and 86. The first and second end cap retention means 114 and 118 can be any device(s), component(s), apparatus(es), system(s) or mechanism(s) suitable to retain the respective first and second end caps 90 and 102 on the proximal end of the respective first or second connector body housings 82 and 86.

For example, in various embodiments, the first and second end cap retention means 114 and 118 can comprise set screws that are threadable through one or more apertures in the side of the respective first or second connector body housings 82 and 86 to fixedly retain the respective end caps 90 and 102 on the proximal ends of the respective first and second body housings 82 and 86. Alternatively, in various other exemplary embodiments, the first and second end cap retention means 114 and 118 can comprise glue suitable to fixedly retain the respective end caps 90 and 102 on the proximal ends of the respective first and second body housings 82 and 86. Or, in various other exemplary embodiments, the first and second end cap retention means 114 and 118 can comprise sonic welds, whereby the end caps 90 and 94 are sonically welded to the respective body housings 82 and 86 to fixedly retain the respective end caps 90 and 102 on the proximal ends of the respective body housings 82 and 86.

In yet other exemplary embodiments, the first and second cap retention means 114 and 118 can comprise rivets, whereby the end caps 90 and 94 are riveted to the respective body housings 82 and 86 to fixedly retain the respective end caps 90 and 102 on the proximal ends of the respective body housings 82 and 86. Or, in still yet other exemplary embodiments, the first and second end cap retention means 114 and 118 can comprise threads disposed on, or in, the end caps 90 and 94 and on, or in, the first and second housings 82 and 86, whereby the end caps 90 and 94 are threadingly engaged with the housings 82 and 86 to fixedly retain the respective end caps 90 and 102 on the proximal ends of the respective body housings 82 and 86.

Thus, in such embodiments, as illustrated in FIGS. 3A and 3B, to connect, or attach, the first and second connectors 58 and 62 to the respective first and second clutch cord ends 50 and 54, the clutch cord ends 50 and 54 are inserted through the apertures 98 and 102 of the respective first and second end caps 90 and 94. Subsequently, the first and second cord retention means 106 and 110 are disposed, connected, attached or formed on the respective first and second clutch cord ends 50 and 54 to retain the respective first and second end caps 90 and 102 on the clutch cord ends 50 and 54. After the first and second end caps 90 and 102 are on the respective first and second clutch cord ends 50 and 54, the end caps 90 and 102 are fixedly retained on the proximal ends of the respective body housings 82 and 86, thereby connecting, or attaching, the first and second connectors 58 and 62 to the respective first and second clutch cord ends 50 and 54.

Referring now to FIGS. 4A and 4B, in various other embodiments, the first and second connector bodies 74 and 78 can be formed as a single structure, or body, respectively including a first and second aperture 122 and 126 disposed in the proximal ends of the respective first and second connector bodies 74 and 78. The respective clutch cord first and second ends 50 and 54 can be inserted through the respective first and second aperture 122 and 126. Additionally, in such embodiments, the first and second connector bodies 74 and 78 can respectively include a first and second cord retention means 130 and 134 structured and operable to fixedly retain the respective first and second connector bodies 74 and 78 on the respective first or second ends 50 and 54 of the clutch cord 42. The first and second cord retention means 130 and 134 can be any device, component, apparatus, system or mechanism suitable to fixedly retain the respective first and second connector bodies 74 and 78 on the respective first and second clutch cord ends 50 and 54.

For example, in various embodiments, each of the first and second retentions means 130 and 134 can include a washer through which the respective clutch cord ends 50 and 54 are inserted and a knot tied in the respective clutch cord ends 50 and 54. Accordingly, the knots prevent the respective clutch cord ends 50 and 54 from pulling through respective washers, and the washer prevent the respective clutch cord ends 50 and 54 from pulling through the respective connector body apertures 122 and 126, thereby retaining the respective connector bodies 74 and 78 on the respective clutch cord ends 50 and 54. Alternatively, in various other exemplary embodiments, the first and second retention means 130 and 134 can be a knot tied in the respective clutch cord ends 50 and 54 and sized to prevent the respective clutch cord ends 50 and 54 from pulling through respective connector body apertures 122 and 126, thereby retaining the respective connector bodies 74 and 78 on the respective clutch cord ends 50 and 54. In yet other exemplary embodiments, the first and second retention means 130 and 134 can be a compression fitting fixedly attached to the respective clutch cord ends 50 and 54, e.g., compressed on to the respective clutch cord ends 50 and 54, such that the respective clutch cord ends 50 and 54 are prevented from pulling through respective connector body apertures 122 and 126, thereby retaining the respective connector bodies 74 and 78 on the respective clutch cord ends 50 and 54.

Referring particularly to FIG. 4A, in various implementations, the first and second magnets 66 and 70 can be disposed on the distal end of the respective first and second connector bodies 74 and 78 subsequent to the clutch cord first and second ends 50 and 54 being inserted through the respective first and second apertures 122 and 126 and the first and second cord retention means 130 and 134 being disposed on the respective clutch cord first or second ends 50 and 54, as described above. In such implementations, the first and second magnets 66 and 70 can be subsequently disposed, in any suitable manner, on the distal end of the respective first and second connector bodies 74 and 78. For example, the first and second magnets 66 and 70 can be glued, ultrasonically welded, snapped, screwed, friction fitted, etc., into or on the distal ends of the respective connector bodies 74 and 78.

Referring particularly to FIG. 4B, in various implementations, the first and second magnets 66 and 70 can be disposed on the distal end of the respective first and second connector bodies 74 and 78, as described above, prior to the clutch cord first and second ends 50 and 54 being inserted through the respective first and second apertures 122 and 126 and the first and second cord retention means 130 and 134 being disposed on the respective clutch cord first or second ends 50 and 54, as described above. In such embodiment, the first and second connector bodies 74 and 78 can include a respective first and second side port 138 and 142 through which the respective clutch cord first and second ends 50 and 54 can be extended after the clutch cord first and second ends 50 and 54 have been inserted through the respective first and second connector body apertures 122 and 126. More specifically, the first and second clutch cord ends 50 and 54 can be inserted through the respective first and second connector body apertures 122 and 126 and then through the respective first and second side ports 138 and 142.

Thereafter, the respective first and second cord retention means 130 and 134 can be disposed on the respective clutch cord first or second ends 50 and 54, as described above. Subsequently, the first and second clutch cord ends 50 and 54 and the first and second cord retention means 130 and 134 can be pulled into an interior of the respective first and second connector bodies 74 and 78 to thereby retain the first and second connector bodies 74 and 78 on the respective first and second clutch cord ends 50 and 54.

Referring now to FIG. 5, in various embodiments, the window covering system 10 can further include a safety clutch cord holding button 146 that is structured and operable to hold the safety clutch cord 22 in a stored position. That is, the safety clutch cord holding button 146 is structured and operable to hold the safety clutch cord 22 in a position wherein the safety clutch cord 22, i.e., the closed loop clutch cord 42 and coupled safety coupling 46, is out of the reach of small children. The safety clutch cord holding button 146 comprises a metallic plate that is attachable to the window opening structure 24, a suitable surface of the head unit 14, or any other surface surrounding the window opening structure. The safety clutch cord holding button 146 is attachable to any of the surfaces/structures via any suitable attaching means, such as glue, nails, screws, double-sided tape, etc.

In operation, the safety clutch cord holding button 146 can be attached to any of the surfaces/structures at a height near the height of the head unit 14. Then, to place the safety clutch cord 22 in the stored position, the safety clutch cord 22 can be operated by applying longitudinal force to any portion of the closed loop safety clutch cord 22, as described above, to position the safety coupling 46 at or near a bottom, or lowest portion, of the closed loop clutch cord 42. The safety coupling 46 can then be lifted and placed in close proximity to the safety clutch cord holding button 146. The attractive magnetic flux field generated by the first and/or second magnets 66 and/or 70 will draw, or pull, the safety coupling 46 into contact with metallic safety clutch cord holding button 146. Furthermore, the attractive magnetic flux field generated by the first and/or second magnets 66 and/or 70 will hold, or retain, the safety coupling 46 in contact with metallic safety clutch cord holding button 146 until sufficient force is applied to remove the safety coupling 46 from the safety clutch cord holding button 146.

Importantly, when the safety clutch cord 22 is placed in the stored position, the loop length LL of safety clutch cord 22 is substantially shortened, e.g., approximately folded in half. The loop length LL of the safety clutch cord 22 in an unstored position is illustrated in FIG. 2A as LL₁, while the loop length of the safety clutch cord 22 in the stored position, via the safety clutch cord holding button 146, is illustrated in FIG. 5 as LL₂. Accordingly, one skilled in the art would readily and clearly understand that LL₂ is substantially shorter than LL₁. Moreover, by substantially shortening the closed loop length LL of the safety clutch cord 22, the safety clutch cord 22 is configured to be out of the reach of small children.

The description herein is merely exemplary in nature and, thus, variations that do not depart from the gist of that which is described are intended to be within the scope of the teachings. Such variations are not to be regarded as a departure from the spirit and scope of the teachings.

1. A safety coupling for a clutch cord of a window covering system, said safety coupling comprising:
a first connector connected to a first end of the clutch cord of the window covering system; and
a second connector connected to a second end of the clutch cord, the second connector magnetically connectable to the first connector to structure the clutch cord in a closed loop that is operable, via application of longitudinal force to any portion of the closed loop clutch cord, to operate a clutch mechanism of the window covering system to move at least a portion of a window covering of the window covering system between a first position and a second position, the first and second connectors magnetically connectable with an amount of attractive force such that:
when a longitudinal force below a predetermined threshold force is applied to either of the first or second connectors, via application of a longitudinal force below the predetermined threshold force to any portion of the closed loop clutch cord, the first and second connectors will remain connected and resulting movement of the closed loop clutch cord will function to operate the clutch mechanism to move the at least a portion of the window covering between the first position and the second position, and
when a longitudinal force greater than or equal to the predetermined threshold force is applied to either of the first or second connectors, via application of a longitudinal force greater than or equal to the predetermined threshold force to any portion of the closed loop clutch cord, the first and second connectors will decouple severing the closed loop clutch cord.

2. The safety coupling of claim 1, wherein the first and second connectors each comprise:
a body connectable to the respective first and second ends of the clutch cord; and
a magnet disposed at a distal end of the body.

3. The safety coupling of claim 2, wherein the body comprises:
a proximal end having an aperture through which the respective first or second end of the clutch cord can be inserted; and
a cord retention means structured and operable to fixedly retain the body on the respective first or second end of the clutch cord.

4. The safety coupling of claim 2, wherein the body comprises:
a housing having the magnet disposed to a distal end thereof;
an end cap connectable to a proximal end of the housing and having an aperture through which the respective first or second end of the clutch cord can be inserted;
a cord retention means structured and operable to fixedly retain the end cap on the respective first or second end of the clutch cord; and
a cap retention means structured and operable to connect the end cap to the proximal end of the housing.

5. A safety clutch cord for a window covering system, said safety clutch cord comprising:
a clutch cord having a first end and second end; and
a safety coupling for detachably connecting the first and second ends of the clutch cord, the safety coupling comprising:
a first connector connected to the first end of the clutch cord; and
a second connector connected to the second end of the clutch cord, the second connector magnetically connectable to the first connector to structure the clutch cord in a closed loop that is operable, via application of longitudinal force to any portion of the closed loop clutch cord, to operate a clutch mechanism of the window covering system to move at least a portion of a window covering of the window covering system between a first position and a second position, the first and second connectors magnetically connectable with an amount of attractive force such that:
when a longitudinal force below a predetermined threshold force is applied to either of the first or second connectors, via application of a longitudinal force below the predetermined threshold force to any portion of the closed loop clutch cord, the first and second connectors will remain connected and resulting movement of the closed loop clutch cord will function to operate the window covering system clutch mechanism to move the at least a portion of the window covering between the first position and the second position, and
when a longitudinal force greater than or equal to the predetermined threshold force is applied to either of the first or second connectors, via application of a longitudinal force greater than or equal to the predetermined threshold force to any portion of the closed loop clutch cord, the first and second connectors will decouple severing the closed loop clutch cord.

6. The safety clutch cord of claim 5, wherein the clutch cord comprises a woven rope cord.

7. The safety clutch cord of claim 5, wherein the clutch cord comprises a beaded cord.

8. The safety clutch cord of claim 5, wherein the clutch cord comprises a metal chain cord.

9. The safety clutch cord of claim 5, wherein the first and second connectors each comprise:
a body connectable to the respective first and second ends of the clutch cord; and
a magnet disposed at a distal end of the body.

10. The safety clutch cord of claim 9, wherein the body comprises:
a proximal end having an aperture through which the respective first or second end of the clutch cord can be inserted; and
a cord retention means structured and operable to fixedly retain the body on the respective first or second end of the clutch cord.

11. The safety clutch cord of claim 9, wherein the body comprises:
a housing having the magnet disposed at a distal end thereof;
an end cap connectable to a proximal end of the housing and having an aperture through which the respective first or second end of the clutch cord can be inserted;
a cord retention means structured and operable to fixedly retain the end cap on the respective first or second end of the clutch cord; and
a cap retention means structured and operable to connect the end cap within the proximal end of the housing.

12. A window covering system, said system comprising:
a head unit mountable to structure forming a window opening, the head unit including a clutch mechanism connected to an end of a window covering movement mechanism such that operation of the clutch mechanism operates the window covering movement mechanism;
a window covering connected to the window covering movement mechanism;
a safety clutch cord disposed about a drive wheel of the clutch mechanism such that movement of the clutch cord rotates the drive wheel to operate the clutch mechanism to operate the window covering movement mechanism to move at least a portion of the window covering between a first position and a second position, the safety clutch cord comprising:
a clutch cord having a first end and second end; and
a safety coupling for detachably connecting the first and second ends of the clutch cord, the safety coupling comprising:
a first connector connected to the first end of the clutch cord; and
a second connector connected to the second end of the clutch cord, the second connector magnetically connectable to the first connector to structure the clutch cord in a closed loop that is operable, via application of longitudinal force to any portion of the closed loop clutch cord, to operate the head unit clutch mechanism to move at least a portion of the window covering between a first position and a second position, the first and second connectors magnetically connectable with an amount of attractive force such that:
when a longitudinal force below a predetermined threshold force is applied to either of the first or second connectors, via application of a longitudinal force below the predetermined threshold force to any portion of the closed loop clutch cord, the first and second connectors will remain connected and resulting movement of the closed loop clutch cord will function to operate the head unit clutch mechanism to move the at least a portion of the window covering between the first position and the second position, and
when a longitudinal force greater than or equal to the predetermined threshold force is applied to either of the first or second connectors, via application of a longitudinal force greater than or equal to the predetermined threshold force to any portion of the closed loop clutch cord, the first and second connectors will decouple severing the closed loop clutch cord.

13. The system of claim 15, wherein the first and second connectors each comprise:
a body connectable to the respective first and second ends of the clutch cord; and
a magnet disposed at a distal end of the body.

14. The system of claim 13, wherein the body comprises:
a proximal end having an aperture through which the respective first or second end of the clutch cord can be inserted; and
a cord retention means structured and operable to fixedly retain the body on the respective first or second end of the clutch cord.

15. The system of claim 13, wherein the body comprises:
a housing having the magnet disposed at a distal end thereof;
an end cap connectable to a proximal end of the housing and having an aperture through which the respective first or second end of the clutch cord can be inserted;
a cord retention means structured and operable to fixedly retain the end cap on the respective first or second end of the clutch cord; and
a cap retention means structured and operable to connect the end cap within the proximal end of the housing.

16. The system of claim 12, wherein the system further includes a safety clutch cord holding button structured and operable to hold the safety clutch cord in a stored position such that a loop length of the safety clutch cord is substantially shortened.

17. The system of claim 12, wherein the window covering comprises one of a roller shade, a pleated horizontal shade, a pleated vertical shade, a set of horizontal blinds, a set of vertical blinds unit, one or more drapes and one or more curtains.

18. A method for providing a safety clutch cord for window covering system, said method comprising:
connecting a first connector of a safety coupling to a first end of a clutch cord of the window covering system, the first connector including a body connectable to the clutch cord first end and a magnet disposed at a distal end of the first connector body; and
connecting a second connector of the safety coupling to a second end of the clutch cord, the second connector including a body connectable to the clutch cord second end and a magnet disposed at a distal end of the second connector body such that the second connector is magnetically connectable to the first connector to structure the clutch cord in a closed loop that is operable, via application of longitudinal force to any portion of the closed loop clutch cord, to operate a clutch mechanism of the window covering system to move at least a portion of a window covering of the window covering system between a first position and a second position, the first and second connectors magnetically connectable with an amount of attractive force such that:
when a longitudinal force below a predetermined threshold force is applied to either of the first or second connectors, via application of a longitudinal force below the predetermined threshold force to any portion of the closed loop clutch cord, the first and second connectors will remain connected and resulting movement of the closed loop clutch cord will function to operate the clutch mechanism to move the at least a portion of the window covering between the first position and the second position, and
when a longitudinal force greater than or equal to the predetermined threshold force is applied to either of the first or second connectors, via application of a longitudinal force greater than or equal to the predetermined threshold force to any portion of the closed loop clutch cord, the first and second connectors will decouple severing the closed loop clutch cord.

19. The method of claim 18, wherein connecting the first connector of the safety coupling to the first end of a clutch cord comprises:
inserting the first end of the clutch cord through an aperture in a proximal end of the first connector body; and
fixedly retaining the first connector body on the clutch cord first end using a cord retention means.

20. The method of claim 18, wherein connecting the second connector of the safety coupling to the second end of a clutch cord comprises:
inserting the second end of the clutch cord through an aperture in a proximal end of the second connector body; and
fixedly retaining the second connector body on the clutch cord second end using a cord retention means.

21. The method of claim 18, wherein connecting the first connector of the safety coupling to the first end of a clutch cord comprises:
inserting the first end of the clutch cord through an aperture in an end cap of the first connector body;
fixedly retaining the first connector end cap on the clutch cord first end using a cord retention means; and
connecting the first connector end cap to a proximal end of a first connector body housing, the first connector body housing having the first connector magnet disposed at a distal end thereof.

22. The method of claim 18, wherein connecting the second connector of the safety coupling to the second end of a clutch cord comprises:
inserting the second end of the clutch cord through an aperture in an end cap of the second connector body;
fixedly retaining the second connector end cap on the clutch cord second end using a cord retention means; and
connecting the second connector end cap to a proximal end of a second connector body housing, the second connector body housing having the second connector magnet disposed at a distal end thereof.
